(19) United States
(12) Patent Application Publication
(10) Pub. No.: US 2013/0084017 A1
(43) Pub. Date: Apr. 4, 2013

(54) IMAGE PROCESSING APPARATUS AND METHOD, PROGRAM AND RECORDING MEDIUM

(71) Applicants: Masatoshi Yokokawa, Kanagawa (JP); Takefumi Nagumo, Kanagawa (JP); Jun Luo, Tokyo (JP)

(72) Inventors: Masatoshi Yokokawa, Kanagawa (JP); Takefumi Nagumo, Kanagawa (JP); Jun Luo, Tokyo (JP)

(73) Assignee: Sony Corporation, Tokyo (JP)

(21) Appl. No.: 13/608,267

(22) Filed: Sep. 10, 2012

(30) Foreign Application Priority Data
Oct. 4, 2011 (JP) 2011-220070

(51) Int. Cl. G06K 9/68

(52) U.S. Cl. 382/218

(57) ABSTRACT

An image processing apparatus includes a motion estimation processing section that detects a motion vector of block units which configure an image from a standard image and a reference image; a motion compensation processing section that produces a motion compensation image by performing motion compensation of the reference image using the motion vector; a difference calculation section that calculates a difference value between pixel values of a pixels of the standard image and pixel values of pixels of the motion compensation image; and a threshold value processing section that determines whether block noise is contained in the motion compensation image of a block unit or not by performing a threshold value processing on the difference value.

### BACKGROUND

The present disclosure relates to an image processing apparatus and a method thereof, a program and a recording medium, more particularly, to an image processing apparatus and a method, a program and a recording medium for detecting block noise more accurately.

Generally, encoding and decoding processing for an image is performed in block units. However, when the compression rate of image signal is high, a gradation difference occurs between adjacent blocks. Particularly, the gradation difference is apt to occur in portions with a moderate change in a gradation. Noise caused by the gradation difference is referred to as block noise.

In order to detect block noise, a first differential value between the adjacent blocks in an image (For example, see Japanese Unexamined Patent Application Publication No. 2001-119695) is obtained.

### SUMMARY

However, in the disclosure described above, when an edge portion contained in an image matches a boundary region of a block, though the block does not contain block noise, there are cases where the block is misdetected as a block containing block noise.

The present disclosure has been made in consideration of such circumstances. It is desirable to detect block noise more accurately.

According to an embodiment of the present disclosure, there is provided an image processing apparatus including a motion estimation processing section that detects a motion vector of block units which configure an image from a standard image and a reference image; a motion compensation processing section that produces a motion compensation image by performing motion compensation of the reference image using the motion vector; a difference calculation section that calculates a difference value between pixel values of pixels of the standard image and pixel values of pixels of the motion compensation image; and a threshold value processing section that determines whether block noise is contained in the motion compensation image of a block unit or not by performing a threshold value processing on the difference value.

The difference calculation detection section may calculate the difference value between the reference image of the block unit and pixel values of pixels of the motion compensation image, the image processing apparatus may further include an approximation processing section that approximates the difference value to a predetermined function and an integration processing section that integrates the predetermined function, and the threshold value processing section may determine whether block noise is contained in the motion compensation image of the block unit or not by performing the threshold value processing on an integration value obtained by the integration processing section.

The difference calculation section may calculate the difference value between the pixel values of the pixels at the boundary region adjacent to the adjacent blocks in a target block at the standard image and the motion compensation image.

The difference calculation section may calculate the difference value between the pixel values of the pixels obtained by sampling the pixels at the boundary region adjacent to the adjacent blocks in the target block.

The threshold value processing section may determine whether block noise is contained in the motion compensation image of a block unit or not by comparing an integration value obtained by the integration processing section with threshold value set based on a noise intensity corresponding to a luminosity value of an image.

The difference calculation section may calculate a difference value between a first differential value obtained by differentiating the pixel values of the pixels of the standard image and a second differential value obtained by differentiating the pixel values of the pixels of the motion compensation image, and the threshold value processing section may determine whether block noise is contained in the motion compensation image of the block unit by performing a threshold value processing on the difference value between the first differential value and the second differential value.

The difference calculation section may calculate the difference value between the first differential value obtained by differentiating the pixel values of the pixels of a boundary region of a target block and an adjacent block, and the second differential value differentiating the pixel value of the pixels of the boundary region of an image of the target block and the adjacent block in the motion compensation image.

An average calculation section calculating an average value of the difference value of the boundary region of the block may be further provided, and the threshold value processing section may determine whether block noise is contained in the motion compensation image of the block unit by performing a threshold value processing on the average value calculated by the average calculation section.

The threshold value processing section may determine whether block noise may be contained in the motion compensation image of the block unit by comparing the difference value between the first differential value and the second differential value with the threshold value set based on the noise intensity corresponding to the luminosity value of the image.

The differential processing section differentiating the difference value calculated by the difference calculation section may be further provided, the threshold value processing section may determine whether block noise is contained in the motion compensation image of the block unit by performing the threshold value processing on the integration value calculated by the differential processing section.

The differential processing section may differentiate the difference value of the boundary region between the target blocks and the adjacent block.

An average value calculation section calculating the average value of the differential value of the boundary region in the block may be further provided, and the threshold value processing section may determine whether block noise is contained in the motion compensation image of the block by performing the threshold value processing on the average value calculated by the average value calculation section.

The threshold value processing section may determine whether block noise is contained in the motion compensation image of the block unit by comparing the differential value calculated by the differential processing section with the threshold value set based on the noise intensity corresponding to the luminosity value of the image.

According to another embodiment of the present disclosure, there is provided an image processing method of an image processing apparatus which includes a motion estimation processing section that detects a motion vector of a block unit having an image from a standard image and a reference image, a motion compensation processing section that produces the motion compensation image by performing a motion compensation of the reference image using the motion vector, a difference calculation section that calculates a difference value of pixel values of pixels of the standard image and pixel values of a pixels of the motion compensation image, and a threshold value processing section that determines whether block noise is contained in the motion compensation image of a block unit by performing a threshold value processing on the difference value, the method including: detecting the motion vector of the block unit having an image from the standard image and the reference image; producing the motion compensation image by performing the motion compensation of a reference image using the motion vector; calculating a difference value between pixel values of pixels of the standard image and pixel values of pixels of a motion compensation image; and determining whether block noise is contained in the motion compensation image of a block unit by performing the threshold value processing on the difference value.

According to still another embodiment of the present, this is provided a program causing a computer to execute a process including detecting a motion vector of a block unit having an image from a standard image and a reference image, producing a motion compensation image by performing a motion compensation of the reference image using the motion vector, calculating a difference value between pixel values of pixels of the standard image and a pixel values of pixels of the motion compensation image; and determining whether block noise is contained in the motion compensation image of a block unit by performing a threshold value processing on the difference value.

According to an embodiment of the disclosure, the method detects a motion vector of a block unit having an image from a standard image and a reference image, produces the motion compensation by performing the motion compensation of the reference image using the motion vector, calculates the difference value between the pixels value of pixels of the standard image and the pixel values of the pixels of the motion compensation image, and determines whether block noise is contained in the motion compensation image of the block unit by performing the threshold value on the difference value.

The present disclosure is able to more accurately detect block noise.

### BRIEF DESCRIPTION OF THE DRAWINGS

FIG. 1 is a block diagram illustrating a functional configuration example of one embodiment of an image processing device according to the disclosure.

FIG. 2 is a block diagram illustrating a first configuration example of a block noise detection section.

FIG. 3 is a view illustrating an arrangement of a block noise detection.

FIG. 4 is a flowchart illustrating an output processing of a block noise detection result.

FIG. 5 is a flowchart illustrating a block noise detection processing by a block noise detection section in FIG. 2.

FIG. 6 is a view illustrating a difference value of a boundary region of the block.

FIG. 7 is a view illustrating noise intensity with respect to a luminosity value.

FIG. 8 is a block diagram illustrating a modification example of a first configuration of a block noise detection.

FIG. 9 is a flowchart illustrating a block noise detection processing by a block noise detection section in FIG. 8.

FIG. 10 is a block diagram illustrating a second configuration example of a block noise detection section.

FIG. 11 is a flowchart illustrating a block noise detection processing by a block noise detection section in FIG. 10.

FIG. 12 is a view illustrating an approximation of a difference value.

FIG. 13 is a view illustrating an integration processing.

FIG. 14 is a view illustrating a quadrature by parts.

FIG. 15 is a view illustrating a quadrature by parts.

FIG. 16 is a block diagram illustrating a configuration example of the hardware of a computer.

### DETAILED DESCRIPTION OF EMBODIMENTS

Embodiments of the present disclosure will be described with reference to the drawings below. The description thereof is carried out according to following sequence.

### 1. Configuration of Image Processing Device

### 2. First Configuration Example of Block Noise Detection Section

### 3. Block Noise Detection Result Output Processing and Block Noise Detection Processing

### 4. Modified Example of First Configuration of Block Noise Detection Section and Block Noise Detection Processing

### 5. Second Configuration Example of Block Noise Detection Section and Block Noise Detection Processing

1. Configuration of Image Processing Device

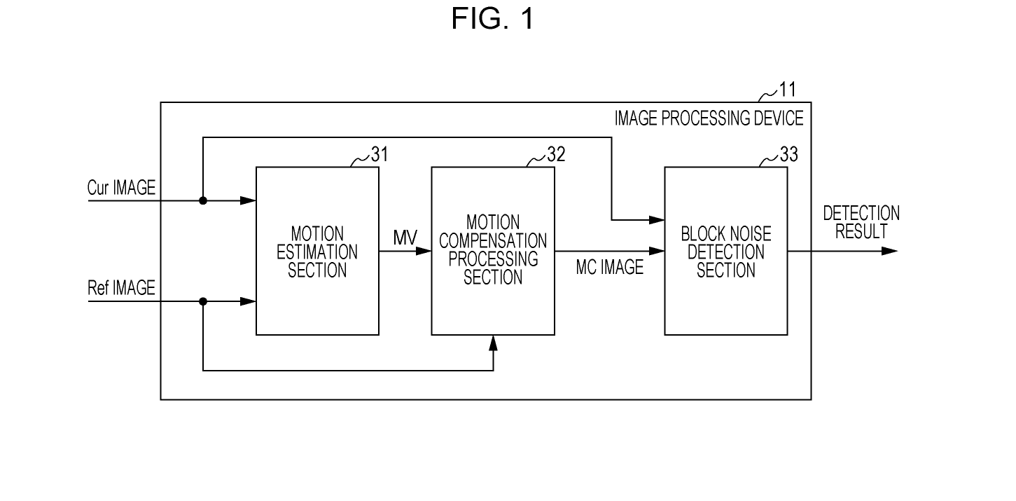

FIG. 1 illustrates a configuration of an embodiment of an image processing device to which disclosure is applied.

The image processing device 11 in FIG. 1, for example, produces an estimation image of a Cur image, which performs block matching using a standard image (hereinafter, referred to as to a Cur image) supplied (input) from an image device (not shown) and a reference image (hereinafter, referred to as Ref image) earlier than the Cur image in time. In addition, the image processing device 11 detects block noise contained in the estimation image and outputs the detection results by comparing the Cur image with the estimation image. Further, the image input in the image processing device 11 is a moving image including a plurality of frames which are temporally continuous, and the Ref image is a noise reduction image on which a noise reduction processing is performed with respect to the Cur image by another image processing device based on the detection result of block noise. In addition, the image processing device 11 itself may be disposed in an imaging device, such as a digital camera and the like.

The image processing device 11 in FIG. 1 includes a motion estimation processing section 31, a motion compensation processing section 32 and a block noise detection section 33.

The motion estimation processing section 31 detects a motion vector MV of a block unit including an image thereof from the Cur image as a frame receiving attention and the Ref image before one frame and supplies the motion vector to the motion compensation processing section 32. In particular, the motion estimation processing section 31 obtains the motion vector MV of a block unit by positioning of the block of the Cur image with a corresponding block of the Ref image.

The motion compensation processing section 32 produces a motion compensation image (hereinafter, referred to as an MC image) positioned to the Cur image on a block unit basis for the Ref image by performing the motion compensation of the Ref image using the motion vector MV of the block unit from the motion estimation processing section 31 and supplies the image to the block noise detection section 33.

The block noise detection section 33 detects block noise contained in the MC image by comparing the Cur image with the MC image from the motion compensation processing section 32 and outputs the detective result. In particular, the block noise detection section 33 detects block noise contained in the MC image of the block unit by obtaining a difference value between pixel values of pixels of the Cur image and pixel values of pixels of the MC image and by performing a threshold value processing on the difference value.

2. First Configuration Example of Block Noise Detection Section

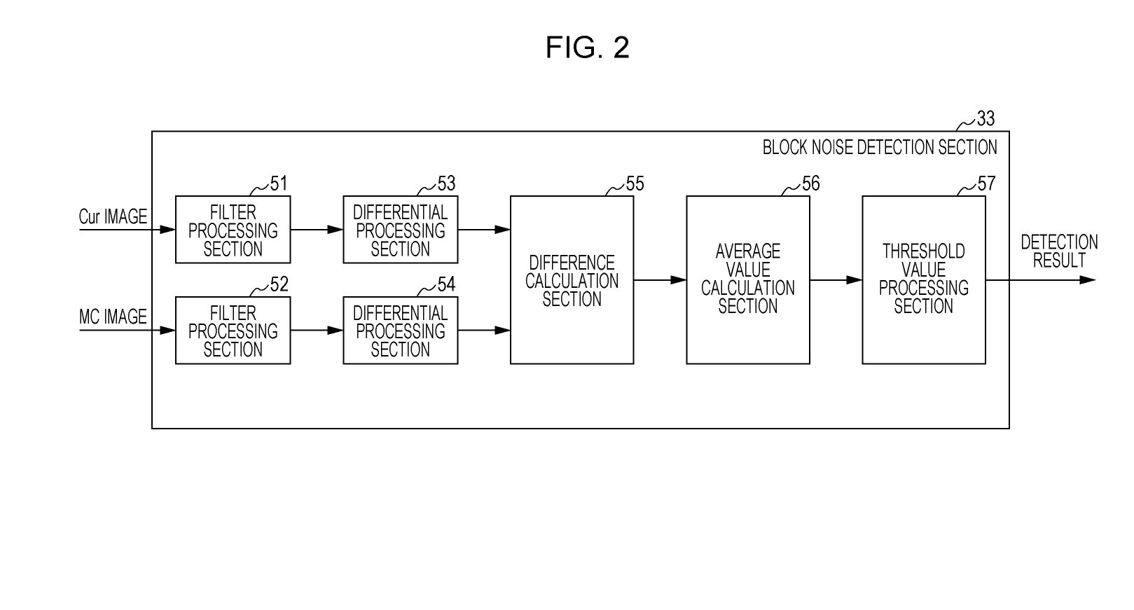

The first configuration example of the block noise detection section 33 will be described with reference to FIG. 2 below.

The block noise detection section 33 in FIG. 2 includes a filter processing section 51, a filter processing section 52, a differential processing section 53, a differential processing section 54, a difference calculation section 55, an average value calculation section 56 and a threshold value processing section 57.

The filter processing section 51 performs a filter processing on the Cur image and supplies the filtered Cur image to the differential processing section 53. Specifically, the filter processing section 51 performs a filter processing on the Cur image using a medium filter and a low pass filter, a combination filter of the medium filter and the low pass filter and the like.

The filter processing section 52 performs the filter processing on the MC image and supplies the filtered MC to the differential processing section 54. Specifically, the filter processing section 52 performs the filter processing on the MC image using the medium filter and the low pass filter and a combination filter of the medium filter and the low pass filter and the like in the same manner as the filter processing section 51.

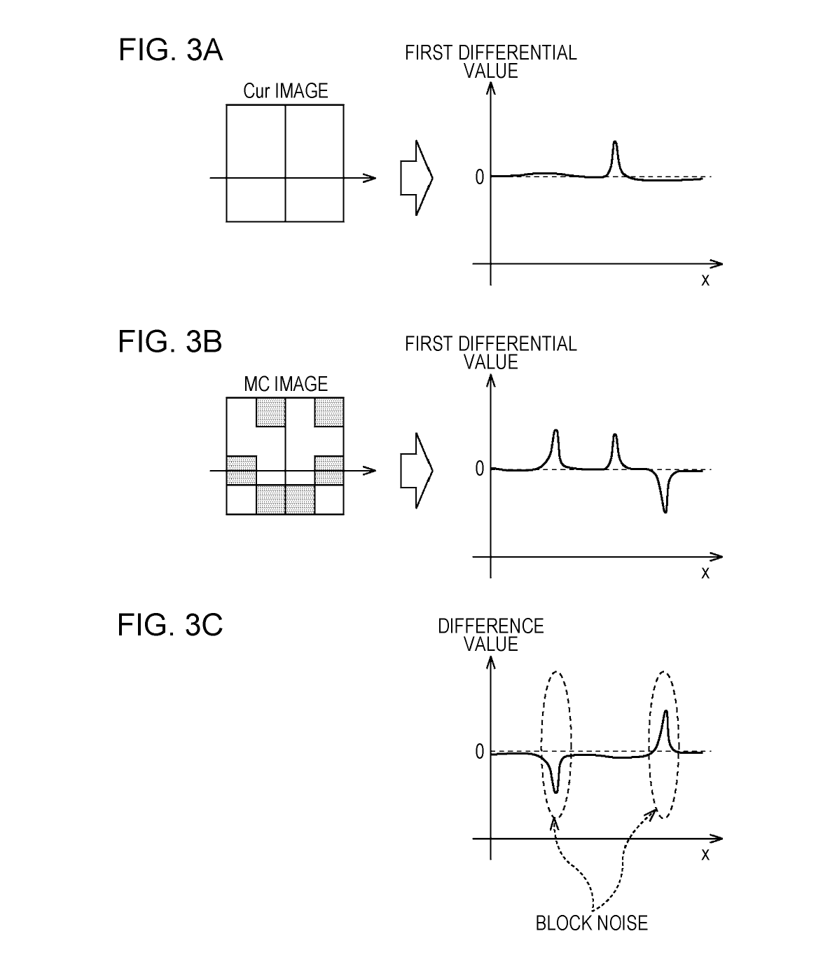

The differential processing section 53 obtains a differential value differentiating the pixel values of the pixels of the Cur image on which the filter processing is performed by the filter processing section 51 and supplies the differential value to the difference calculation section 55. For example, as illustrated in FIG. 3A, the difference value (a first differential value) of the pixel values between the pixels of the Cur image which is parallel to the direction of the arrow in the drawings is obtained. As illustrated in FIG. 3A, the first differential value of the Cur image increases at an edge part in the Cur image (a central part in the longitudinal direction in the Cur image).

The differential processing section 54 obtains the differential value differentiating the pixel values of the pixels of MC image on which the filter processing is performed by the filter processing section 52 and supplies the differential value to the difference calculation section 55. For example, as illustrated in FIG. 3B, the difference value (a first differential value) of the pixel values between the pixels of MC image of the block unit which is parallel to the direction of the arrow in the drawings (x axis direction) is obtained. As illustrated in FIG. 3B, the first differential value of the MC image increases at a boundary region between an edge part in the MC image (a central part in the longitudinal direction of Cur image) and the block (shaded block) containing block noise.

The difference calculation section 55 calculates the difference value between the differential value of the Cur image from the differential processing section 53 and the differential value of the MC image from the differential processing section 54 and supplies the difference value to the average value calculation section 56. That is, in the difference value between the first differential value of the Cur image illustrated in FIG. 3A and the first differential value of MC image illustrated in FIG. 3B, the value of each edge thereof is offset and only the boundary region of the block including block noise is formed to have a value as illustrated in FIG. 3C.

The average value calculation section 56 calculates the average value of the difference value from the difference calculation section 55 on a block unit basis and supplies the value to the threshold value processing section 57.

The threshold value processing section 57 outputs the detection result indicating whether block noise is contained in the MC image of the block by determining whether the average value from the average value calculation section 56 is higher than the predetermined threshold value on a block unit.

3. Block Noise Detection Result Output Processing and Block Noise Detection Processing

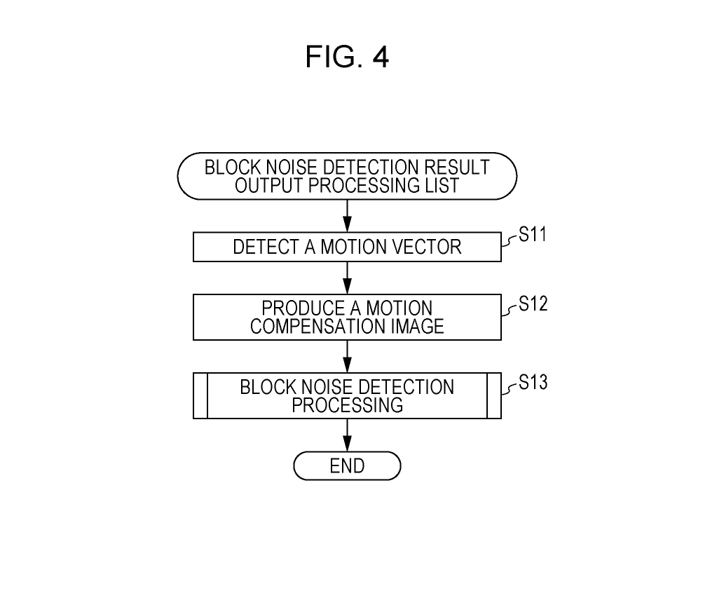

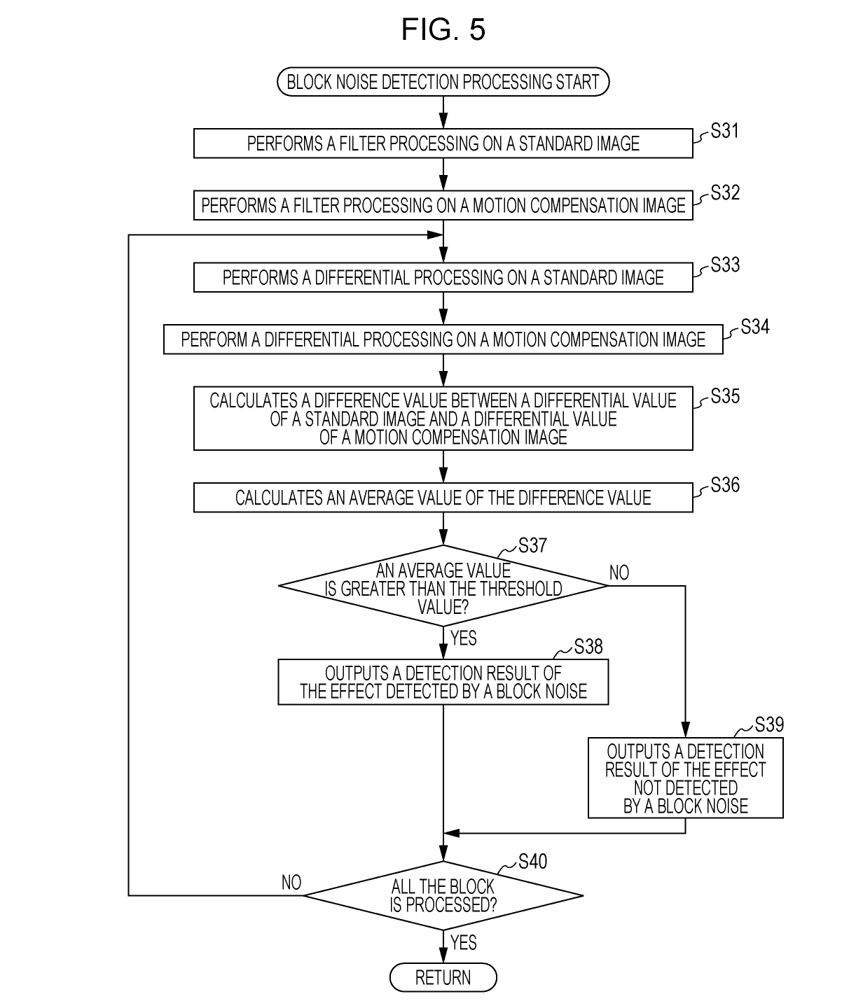

Next, referring to a flowchart of FIG. 4 and FIG. 5, the block noise detection result output processing by the image processing device 11 in FIG. 1 and the block noise detection processing by the block noise detection section 33 in FIG. 2 will be described.

Block Noise Detection Result Output Processing

First, referring to the flowchart in FIG. 4, the block noise detection result output processing in an image processing apparatus 11 described FIG. 1 will be described.

In step S11, the motion estimation processing section 31 detects the motion vector MN for each block from the Cur image and the Ref image and supplies the detected vector MN to the motion compensation processing section 32.

In step S12, the motion compensation processing section 32 produces the motion compensation image (MC image) by performing the motion compensation of the Ref image using the motion vector MV from the motion estimation processing section 31 and supplies the motion compensation image to the block noise detection section 33.

In step S13, the block noise detection section 33 detects the block noise contained in the MC image by performing the block noise detection processing.

As described above, the detection result of block noise in the MC image is output.

Block Noise Detection Processing

Next, referring to a flowchart in FIG. 5, the block noise detection processing in step S13 of the flowchart in FIG. 4 will be described.

In step S31, the filter processing section 51 performs the filter processing on the Cur image and supplies the Cur image to the differential processing section 53.

In step S32, the filter processing section 52 performs the filter processing on the MC image and supplies the MC image to the differential processing section 54.

As described above, the noise contained in each image may be controlled by performing the filter processing on the Cur image and the MC image. In addition, the processing In step S31 and S32 may be executed in parallel.

In step S33, the differential processing section 53 performs the differential processing on the Cur image of the boundary region between the target block on which the filter processing is performed by the filter processing section 51 and receiving attention, and the adjacent block adjacent to the target block. In particular, the differential processing section 53 obtains a difference value between four sides of the target block and the pixel values of the pixels of the adjacent blocks adjacent to the four sides by Cur image and supplies difference value to difference calculation section 55.

In step S34, the differential processing section 54 performs the differential processing on the MC image of the boundary region between the target block on which the filter processing is performed by the filter processing section 52, and the adjacent block. Specifically, the differential processing section 54 obtains the difference value between the four sides of the target block and the pixel value of the pixels of the pixels of the adjacent blocks adjacent the four sides and supplies the difference value to the difference calculation section 55.

In step S35, the differential calculation section 55 calculates the difference value between the differential value (difference value) of the Cur image of the four sides of the target block from the differential processing section 53 and the differential value (difference value) of the MC image of the four sides of the target block from the differential processing section 54, and supplies the difference value to the average value calculation section 56.

In step S36, the average value calculation section 56 calculates the average value of the difference value of the four sides from the difference calculation section 55 for each side and supplies the average value to the threshold value processing section 57. For example, if one block includes 8×8 pixels, the average value calculation section 56 calculates the average value of the difference value of eight pixels for each side.

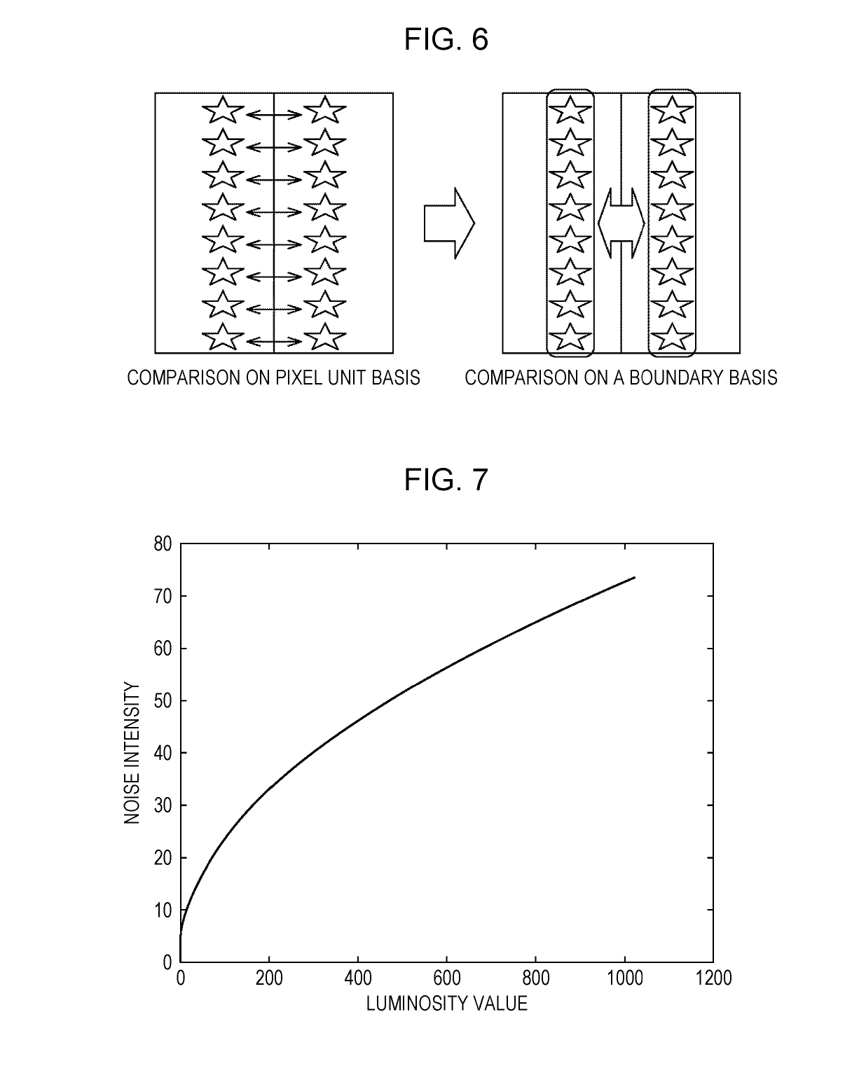

That is, as illustrated on the right side in FIG. 6, the pixel value of the boundary region between the target block and the adjacent block does not use the value compared on the pixels (pixels) basis, but the value that the pixel values of the boundary region between the target block and the adjacent block is compared on the boundary region basis (one side unit of the block) is used. As described above, it may be possible to suppress the influence of noise caused by the image sensor contained in the Cur image by adding and averaging the differential value.

Herein, if the differential value (difference value) of the Cur image is ΔCur and the differential value (difference value) of the MC image is ΔMc, the average value block_strength obtained by the average value calculation section 56 is expressed by the following Equation 1.

$$block\_strength = abs ( \frac{1}{BlockSize} {\sum }_{BlockSize}^{ } ( Δ Cur - Δ M c ) ) \qquad ( 1 )$$

In addition, block size in the Equation 1 is a block size of, for example, eight. Further, the Equation 1, abs(A) shows the absolute value of A. The larger the value of the average value block_strength, the more a gradation difference occurs between the target block and the adjacent block.

In addition, although the average value of the difference value is obtained with respect to each of four sides of the block, for example, any one of the difference value of eight pixels worth (one side part of the block) may be handled as the average value.

Accordingly, the average value for the target block is four, that is, four sides worth of the block is obtained.

Returning to the flowchart in FIG. 5, In step S37, the threshold value processing section 57 determines whether the average value for the respective four sides of block from the average value calculation section 56 is higher than the threshold value set based on the noise intensity with respect to the luminosity value which is obtained in advance or not.

FIG. 7 illustrates the noise intensity with respect to the luminosity value of the image obtained by the imaging device (not shown).

In FIG. 7, a horizontal axis shows the luminosity values of the pixels, and a longitudinal axis shows the noise intensity. Since the noise intensity has variations due to the pixels, the distribution of the noise intensity for each pixel in the overall image is obtained in advance such that the noise intensity illustrated in FIG. 7 is obtained based on the noise intensity distribution.

In addition, the noise intensity is provided with respect to the luminosity value (a luminosity signal) of three channels of R, G and B, and the noise intensity shown in FIG. 7, for example, shows the noise intensity with respect to a G signal.

That is, the threshold value processing section 57 sets the threshold value Th based on the noise intensity corresponding to the luminosity value from a relationship shown in FIG. 7 on the basis of the luminosity value (for example, G signal) of the pixels in the Cur image of the target block. In addition, the threshold value processing section 57 compares the threshold value Th with the average value for the respective four sides of the block from the average value calculation section 56 using the Equation 2 below to determine whether the average value is higher than the threshold value or not.

$$abs ( \frac{1}{BlockSize} {\sum }_{BlockSize}^{ } ( Δ Cur - Δ M c ) ) > Th \qquad ( 2 )$$

In step S37, if it is determined that any one of the average values for the respective four sides of the block is higher than the threshold value, the process proceeds to step S38, and the threshold value processing section 57 outputs a detection result to the effect that block noise was detected.

Meanwhile, In step S37, if it is determined that all of the average values for the respective four sides of the block is not higher than the threshold value, the process proceeds to step S39, and the threshold value processing section 57 outputs the detection result to the effect that block noise was not detected.

In step S40, the threshold value processing section 57 determines whether the processing is made with respect to all of the blocks.

In step S40, if it is determined that the process is not completed with respect to all of the blocks, the process returns to the step S33 and the subsequent process is repeated.

Meanwhile, in step S40, if it is determined that the process is completed with respect to all of the blocks, the block noise detection process is terminated. After that, the process returns to the step 13 of the flowchart in FIG. 4.

According to the above-mentioned process, the difference value between the differential value of the block boundary region of the Cur image and the differential of the block boundary region of the MC image is calculated, and block noise contained in the block of the MC image is detected by determining whether the difference value is higher than the threshold value set according to the noise intensity. Accordingly, even if the edge part contained in the image matches the boundary region of the block, since the value of the edge part is offset, it possible to detect block noise more accurately without misdetecting block noise at the edge part.

In addition, by using the threshold value set in response to the noise intensity, even if the luminance varies in the imaging environment threshold value, since the threshold value processing can be performed with respect to the noise intensity corresponding to the luminosity value at that time, it is possible to detect block noise more accurately even with respect to luminance variations.

In addition, as described above, if it is determined that any one of the average values for the respective four sides of the block is higher than the threshold value, the detection result to the effect which block noise is detected is output, but if it is determined that one (for example, two or three) or all for each four sides of the block is higher than the threshold value, the detection result to the effects that block noise is detected, may be output.

As described above, although the configuration was described in which the difference value is obtained from the differential value by obtaining each difference value from the differential value of Cur image and MC image the configuration will be described below in which the difference value of the Cur image and the MC image is obtained to obtain the differential value thereof.

4. Modified Example of First Configuration of Block Noise Detection Section and Block Noise Detection Processing

Modified Example of First Configuration of Block Noise Detection Section

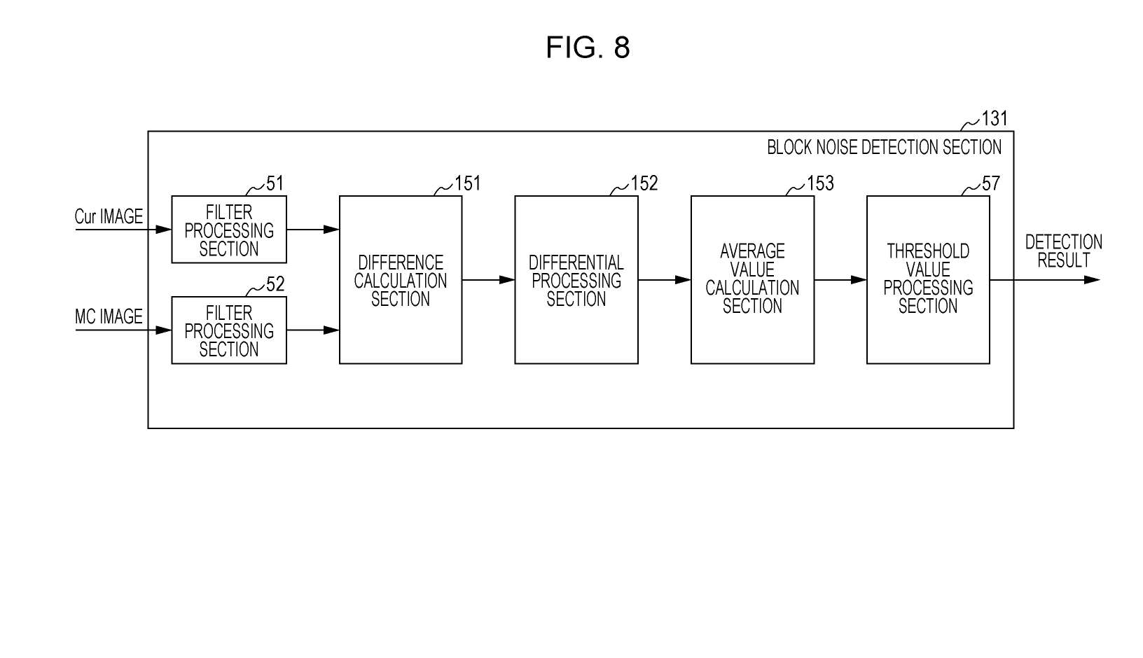

First, the modified example of first configuration of the block noise detection section will be described with reference to FIG. 8.

A block noise detection section 131 in FIG. 8 includes a filter processing section 51, a filter processing section 52, a threshold value processing section 57, a difference calculation section 151, a differential processing section 152 and an average value calculation 153.

In addition, in the block noise detection section 131 in FIG. 8, the same names and reference numerals are used for configurations having the same function as the configurations disposed in the block noise detection section 33 in FIG. 2, and therefore, description thereof is omitted.

That is, the difference calculation section 151 calculates a difference value between pixel values of a pixels of a Cur image on which the filter processing is performed by the filter processing section 51, and a pixel values of pixels of a MC image on which the filter processing is performed by the filter processing section 52 and supplies the calculated difference value to the differential processing section 152.

The differential processing section 152 obtains a differential value which is differentiated from difference value from the difference calculation section 151 and supplies the differential value to the average value calculation section 153.

The average value calculation section 153 calculates the average value of the differential value from the differential processing section 152 on a block basis and supplies the average value to the threshold value processing section 57.

Block Noise Detection Processing

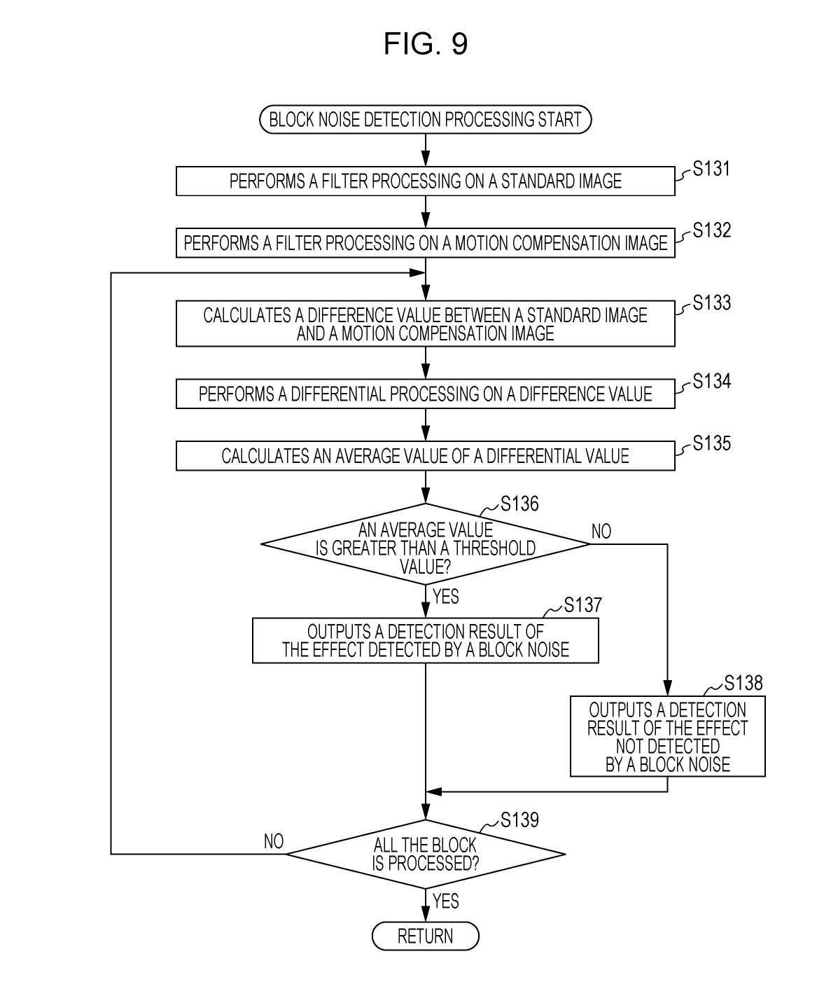

Next, referring to a flowchart of FIG. 9, the block noise detection processing by the block noise detection section 131 in FIG. 8 will be described.

In addition, since the processing of the flowchart of step S131, S132, S136 to S139 in FIG. 9 is identical to the processing of flowchart of step S31, S32, S37 to S40 in FIG. 5, the description thereof is omitted.

That is, in step S133, the difference calculation section 151 calculates the difference value between the pixel values of the pixels of Cur image from the filter processing section 51, and the pixel values of the pixels of the MC image from the filter processing section 52 and supplies the difference value to the differential processing section 152.

In step S134, the differential processing section 152 performs the differential processing on a difference value from the difference calculation section 151. In detail, the differential processing section 152 obtains the four sides of the target block between the differential value (difference value) of the difference value of pixels of an adjacent block adjacent to the four sides, and supplies it to the average value calculation section 153.

In step S135, the average value calculation section 153 calculates the average value of the differential value of the four sides from the differential processing section 152 for each side, and supplies it to the threshold value processing section 57.

The same effects as block noise detection processing illustrated in the flowchart in FIG. 9 are exhibited even in the block noise detection processing illustrated in the flowchart in FIG. 5.

5. Second Configuration Example of Block Noise Detection Processing Section and Block Noise Detection Processing

Second Configuration Example of Block Noise Detection Processing Section

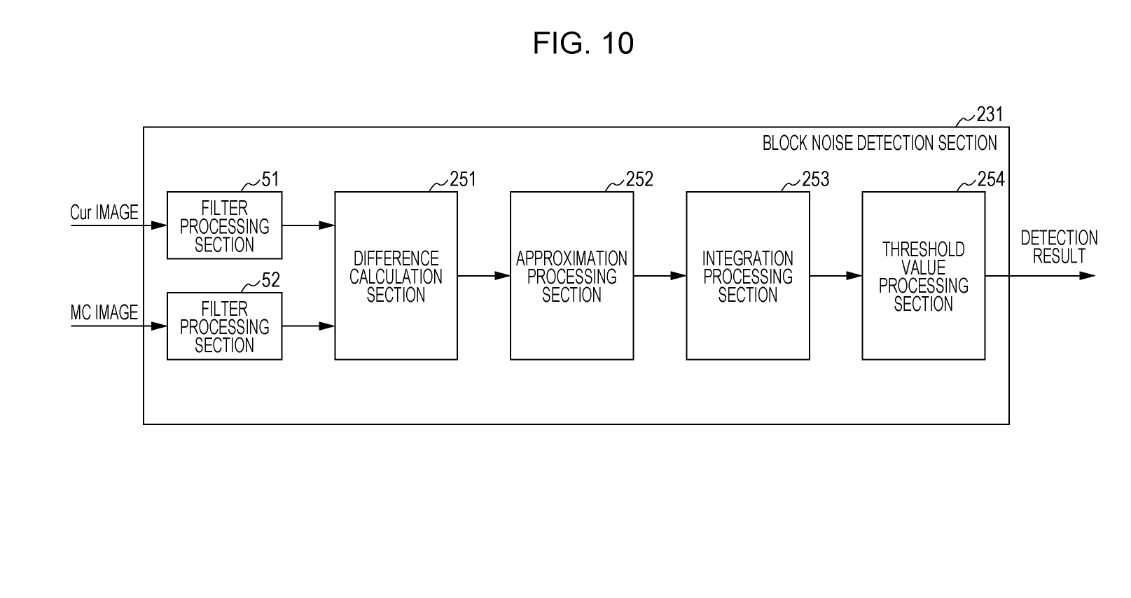

Next, a second configuration example of the block noise detection processing section will be described with reference to FIG. 10.

The block noise detection section 231 in FIG. 10 includes a filter processing section 51, a filter processing section 52, a difference calculation section 251, an approximation processing section 252, an integration processing section 253 and a threshold value processing section 254.

In addition, in the block noise detection section 231 in FIG. 10, the same names and reference numerals are used for configurations having the same function as the configurations disposed in the block noise detection section 33 in FIG. 2, and therefore, description thereof is omitted.

That is, the difference calculation section 251 calculates the difference value between the pixel value of the pixels of the Cur image on which the filter processing is performed by the filter processing section 51 and the pixel value of the pixels of the MC image on which the filter processing is performed by the filter processing section 52 and supplies the pixel value to the approximation section 252.

The approximation processing section 252 approximates the difference value from the difference calculation section 251 to a predetermined function and supplies it to the integration processing section 253.

The integration processing section 253 performs an integration processing on the function from the approximation processing section 252 and supplies the obtained integration value to the threshold value processing section 254.

The threshold value processing section 254 outputs the detection result indicating whether block noise is contained in the MC image of the block by determining whether the integration value from the integration processing section 253 is higher than a predetermined threshold value for a block unit.

Block Noise Detection Processing

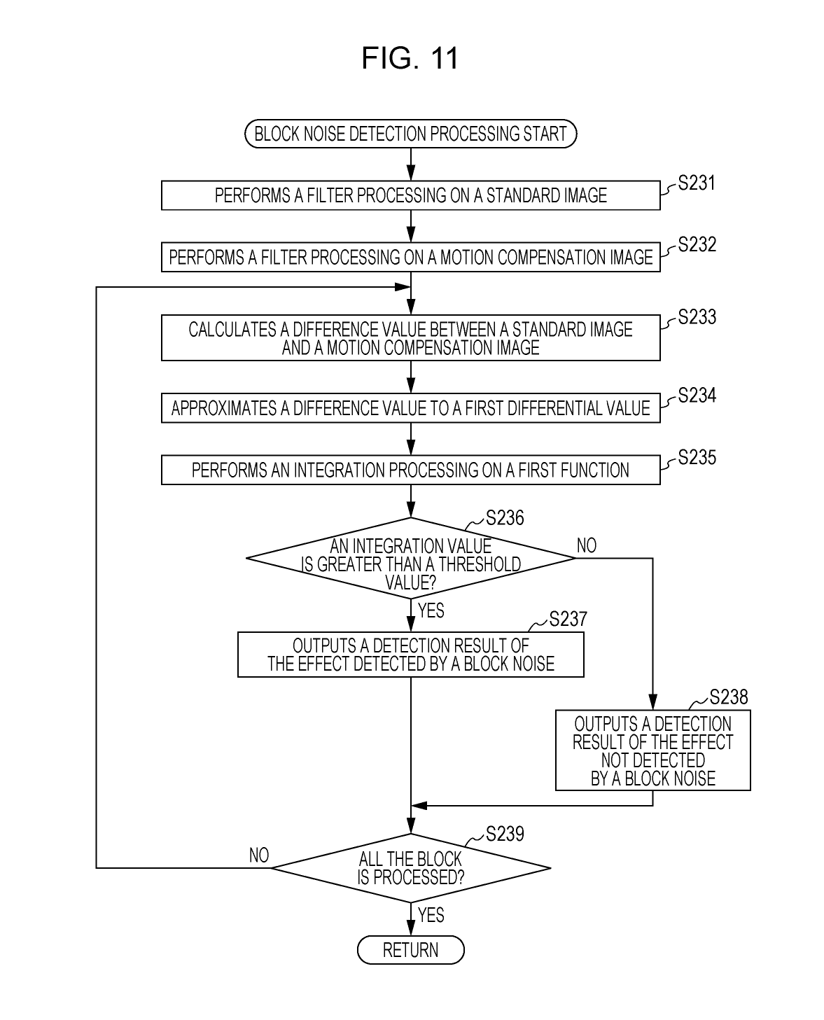

Herein, referring to the flowchart in FIG. 11, the block noise detection processing by the block noise detection section 231 in FIG. 10 will be described.

In addition, the processing of steps S231 and S232 of the flowchart in FIG. 11 is identical to that of steps S31 and S32 of the flowchart in FIG. 5. Accordingly, description thereof is omitted.

That is, In step S233, the difference calculation section 251 calculates the difference value between the pixel values of pixels of the boundary region adjacent to the adjacent block of the target block of the Cur image on which the filter processing is performed by the filter processing section 51, and the pixel values of the pixels of the boundary region adjacent to the adjacent block of the target block of the MC image on which the filter processing is performed by the filter processing section 52 and supplies it to the approximation processing section 252. Specifically, the difference calculation section 251 obtains the difference value of the pixel values of the pixels including the four sides of the target block of Cur image and Mc image.

In step s234, the approximation processing section 252 approximates the difference value of the four sides of the target block to the linear function from the difference calculation section 251 and supplies it to the integration processing section 253.

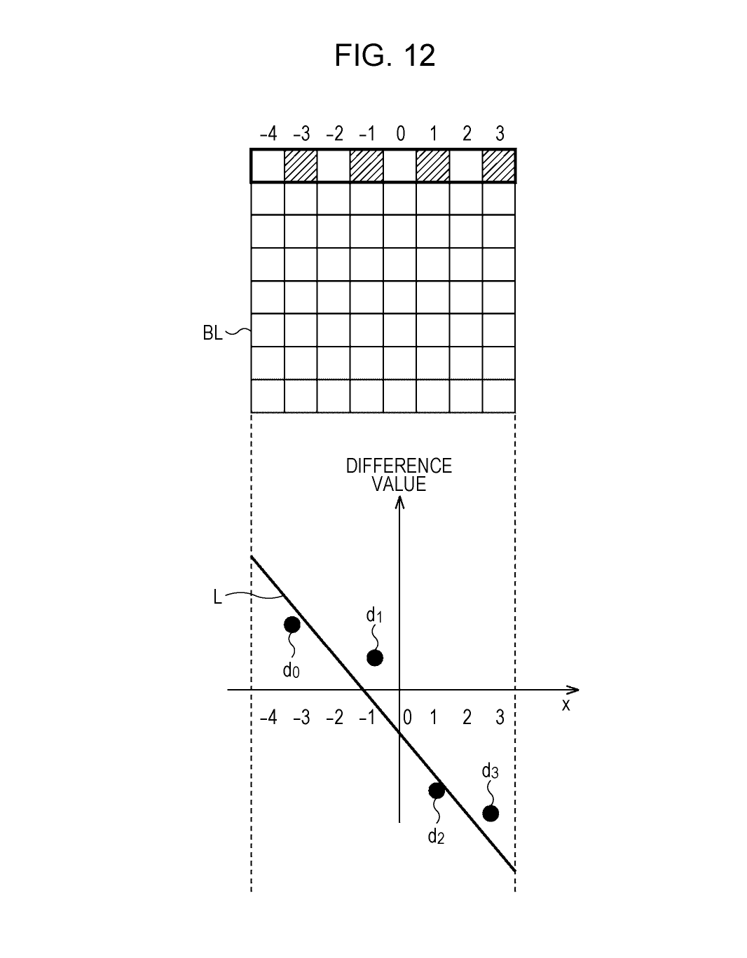

For example, for the target block BL of 8×8 pixels illustrated in FIG. 12, the difference value (bold line part in the drawings) of the pixels including the upper side of the four sides is given at d₀ to d₃. In addition, since the target block BL is configured by 8×8 pixels, the difference value of eight is obtained per side. However, herein, the four difference values d₀ to d₃ are obtained by sampling the pixels (skipping one image) with respect to four pixels of the pixels positions −3, −1, 1, 3. As described above, it is possible to reduce an operation cost by obtaining the differential value obtained by pixels.

In this case, the approximation processing section 252 obtains a primary approximates straight line L with respect to the four difference values d₀ to d₃. As described above, it is possible to suppress the influence of noise caused by the image sensor contained in Cur image by obtaining the approximation value by obtaining a primary approximates straight line.

In step S235, the integration processing section 253 performs the integration processing with respect to a linear function obtained by the approximation processing section 252 and supplies the integration value obtained with respect to each of four sides of the target block to the threshold value processing section 254.

In other words, if the pixels position shown in FIG. 12 is a coordinate of the x axis, the integration processing section 253 performs the integration processing with respect to the linear function obtained by the approximation processing section 252 using the following Equation 3.

$${\int }_{- 4}^{3} \vert a x + b \vert d x \qquad ( 3 )$$

In the Equation 3, the value a represents the slope of a primary approximate straight line L and value b represents an intercept of the primary approximate straight line L.

In addition, if the value a and the value b are calculated using the difference value dₒ to d₃ by the least squares method, the Equation 3 is represented by the following Equation 4.

$$M = {\int }_{- 4}^{3} \vert \frac{3 {d}_{0} + {d}_{1} - {d}_{2} - 3 {d}_{3}}{20} x + \frac{- 2 {d}_{0} + {d}_{1} + 4 {d}_{2} + 7 {d}_{3}}{10} \vert d x \qquad ( 4 )$$

As described above, the integration value for the target block is four, that is, the four sides of the block.

Returning to the flowchart in FIG. 11, In step S236, the threshold value processing section 254 determines whether the integration value for the respective four sides of the block from the integration processing section 253 is higher than the threshold value set based on the noise intensity with respect to the luminosity value obtained in advance.

Specifically, the threshold value processing section 254 sets the threshold value Th based on the noise intensity corresponding to the luminosity value based on the luminosity value (for example, G signal) of the pixels in the Cur image of the target block from the relationship illustrated in FIG. 7. In addition, the threshold value processing section 254 compares the threshold value Th with the integration value from the integration processing section 253 using the Equation 5 and determines whether the integration value for the respective four sides of the block is higher than threshold value or not.

$${\int }_{- 4}^{3} \vert a x + b \vert d x > Th \qquad ( 5 )$$

In step S236, if any one of the integration value for the four sides of the block is higher than the threshold value, the process proceeds to step S237 and the threshold value processing section 234 outputs the detection result to the effect that block noise is detected.

Meanwhile, in step S236, if it is determined that all of the integration values for the respective four sides of the block is not higher than the threshold value, the processing proceeds to step S238 and the threshold value processing section 234 outputs the detection result to the effect that noise is not detected.

In step S239, the threshold value processing section 234 determines whether the processing is made with respect to all of the blocks.

In step S234, if it is determined that the processing is not made for all of the blocks, the processing returns to step S233, the following processing is repeated.

Meanwhile, in step S234, if it is determined that the processing is made for all of the blocks, the block noise detection processing is completed.

According to the processing described above, the difference value between the pixel values of the block boundary region of the Cur image and the pixel values of the block boundary region of the MC image is calculated and the determination is made whether the integration value of the approximation function of the difference value is higher than the threshold value set according to the noise intensity, so that block noise contained in the block of MC image is detected. Accordingly, even if an edge part contained in the image matches the boundary region of the block, since the value of the edge part is offset, it is possible to detect block noise more accurately.

Further, even though the illumination varies in the imaging environment by using the threshold value set according to the noise intensity, since the threshold value processing can be performed in response to the noise intensity corresponding to the luminosity value at that time, it is possible to detect block noise more accurately without misdetecting the block noise at the edge parts.

In addition, in the processing described above, since it is not necessary to obtain the difference value (differential value) between the pixels of the target block and the pixels of the adjacent block, only the target block may be referenced and it is possible to reduce operation costcompared with the processing that then references and describes the flowchart in FIG. 5 and FIG. 9.

In addition, in a description described above, if it is determined that any one of the integration value for each of four sides of the block is higher than the threshold value, the detection result to the effect that block noise is detected, is output. However, if it is determined that at least one (for example, two or three) or all of the integration values for each four sides of the block is higher than the threshold value, the detection result to the effect that block noise is detected, may be output.

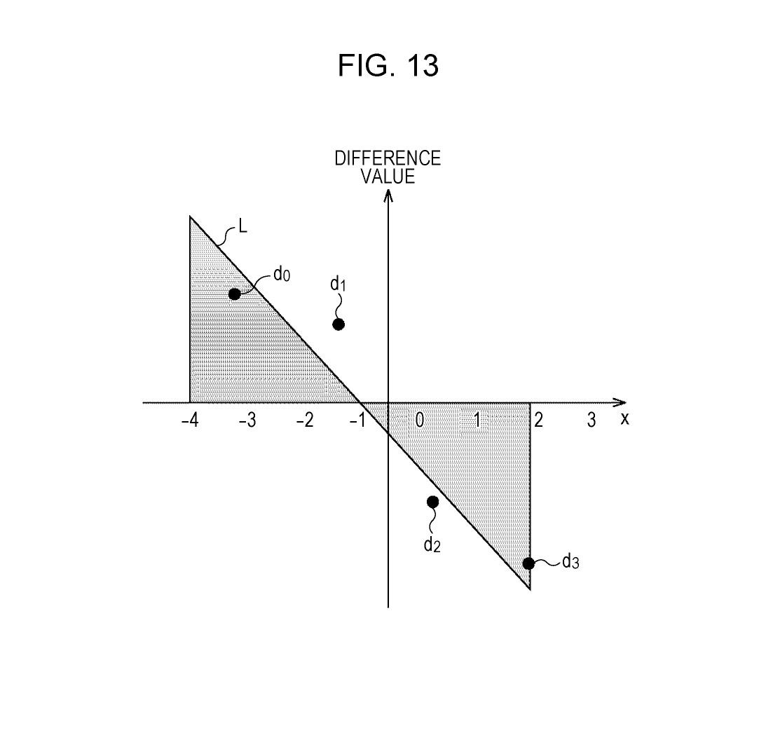

In addition, in step S235 described above, the integration processing is performed on the primary approximate straight line L. However, it is identical to obtaining the area of a shaded area, which is given at x axis of the primary approximate straight line L as shown in FIG. 13.

In order to simply the process, the quadrature by parts method for the primary approximate straight line L may be used in place of the integration processing for the primary approximate straight line L.

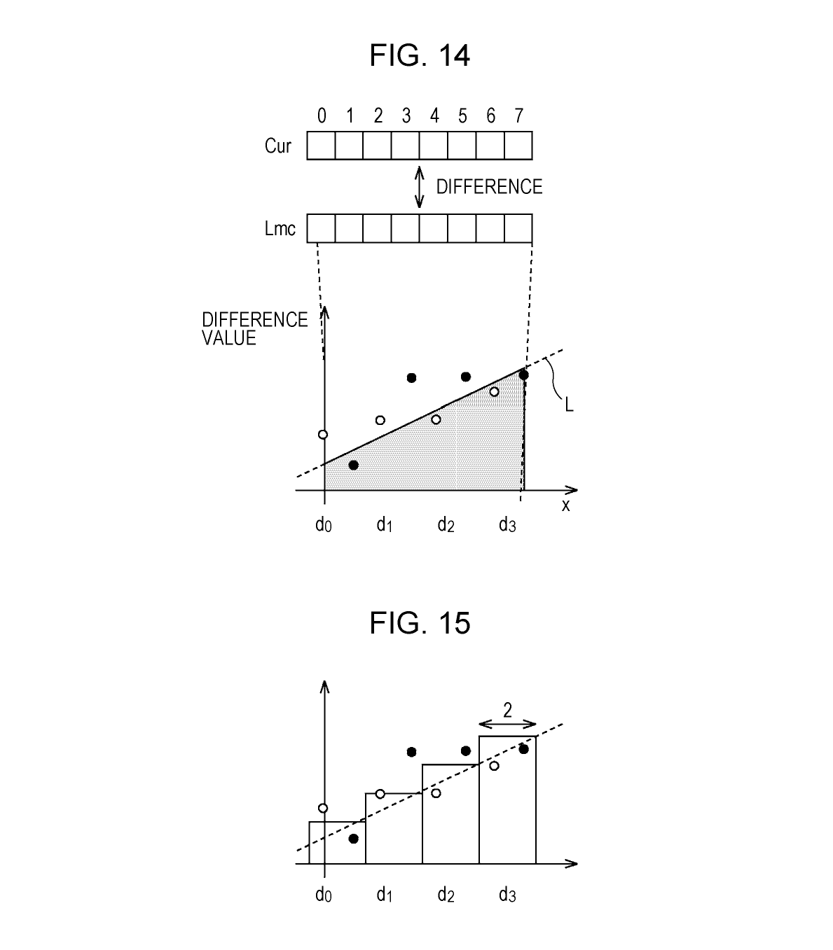

For example, in illustrated in FIG. 14, if the difference value and the primary approximate straight line L for one predetermined side of the target block are given, the integration for the primary approximate straight line L, that is, the area of the shaded area is calculated by obtaining the size of four rectangular regions in FIG. 15.

In addition, if one block contains 8×8 pixels and the integration value (area) is obtained using four pixels (difference value) for one side of the block, the width having the rectangle in FIG. 15 become two and the height become the primary approximate straight line L for each pixel.

Herein, if the area of the four rectangular regions is A, the area A is given as the following Equation 6.

$$A = ( \vert \frac{- 2 {d}_{0} + {d}_{1} + 4 {d}_{2} + 7 {d}_{3}}{10} \vert + \vert \frac{{d}_{0} + 2 {d}_{1} + 3 {d}_{2} + 4 {d}_{3}}{10} \vert + \vert \frac{4 {d}_{0} + 3 {d}_{1} + 2 {d}_{2} + {d}_{3}}{10} \vert + \vert \frac{7 {d}_{0} + 4 {d}_{1} + {d}_{2} - 2 {d}_{3}}{10} \vert ) \times 2 \qquad ( 6 )$$

In the Equation 6, dₒ is the difference in x=0d₁ is the difference value in x=2, d₂ is the difference value in x=4 and, d₃ is the difference value in x=6, respectively, and the Equation 6 can be expanded as Equation 7.

5A=|−2d₀+d₁+4d₂+7d₃|+|d₀+2d₁+3d₂+4d₃|+|4d₀+3d₁+2d₂+d₃|+|7d₀+4d₁+d₂−2d₃| (7)

As described above, since quadrature by parts is used instead of the integration processing, an operation becomes simple, so that it is possible to reduce the operation cost.

The above mentioned serial processing can be performed by hardware and can be also performed by software. If the serial processing is performed by software, a program which configures the software is installed on a computer into which dedicated hardware is incorporated or a general purpose computer and the like that can perform various functions by installing the various programs from a recording medium.

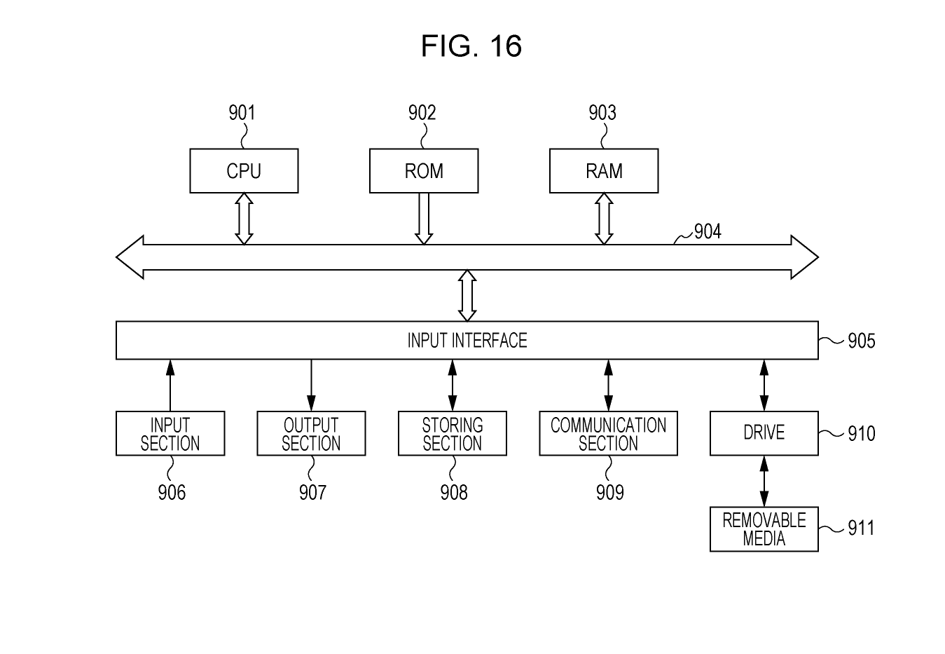

FIG. 16 is a block diagram illustrating a configuration example of the hardware of the computer performing the above-mentioned serial processes using the program.

In the computer, a central processing unit (CPU) 901, a read only memory (ROM) 902 and a random access memory (RAM) 903 are connected to each other by a bus 904.

An input-output interface 905 is further connected to the bus 904. An input section 906 including a keyboard, a mouse, a microphone and the like, an output section 907 including a display, a speaker and the like, a storage section 908 including a hard disk and a non-volatile memory or the like, a communication section 909 including a network interface and the like, and a drive 910 driving a removable medium 911 such as a magnetic disk, an optical disc or magneto-optical disc or a semiconductor memory and the like are connected to the input-output interface 905.

In a computer configured as described above, CPU 901, for example, loads the program stored in the storing 908 via the input-output interface 905 and the bus 904 onto the RAM 903 for performance thereof to perform the above-mentioned serial processing.

The program performed by the computer (CPU 901) for example, is stored medium on a removable medium 911, a package medium including a magnetic disk (including flexible disk), an optical disc (compact disc read only memory (CD-ROM)), a digital versatile disk (DVD) and the like), a magneto-optical disc, or the package medium such as a semiconductor and the like and the like including the semiconductor or is provided via transmission medium of the wire and wireless composed of a local area network, an internet, a digital satellite broadcast.

In addition, since the program connects the medium removable medium 911 to the drive 910, the program can be installed in the storage section 908 via the input-output interface 905. Further, the program is received at the communication section 909 via a wired or wireless transmission medium and can be installed in the storage section 908. Additionally, the program can be installed in advance in the ROM 902 or the storage section 908.

In addition, the program performed by the computer may be a program that the processing is performed in time series order according to a sequence described in the specification, or program where the processing is performed in parallel or a timing necessary when called or the like.

In addition, the embodiment of the disclosure is not limited to the embodiment described above and various modifications can be made without departing from the spirit and scope in the disclosure.

For example, the disclosure may be a cloud computing configuration which performs processing by sharing and cooperation of a plurality of devices through a network.

In addition, the plurality of device can share each step described in the above-mentioned flowchart with the plurality of devices, in addition to performing the step using one device.

Further, if a plurality of processes is included in one step, the plurality of processes contained in one step is performed by sharing the plurality of processes contained in one step with a plurality of devices in addition to performing by one advice.

In addition, the present disclosure has a following configuration.

(1) An image processing apparatus including:

a motion estimation processing section that detects a motion vector of block units which configure an image from a standard image and a reference image;

a motion compensation processing section that produces a motion compensation image by performing motion compensation of the reference image using the motion vector;

a difference calculation section that calculates a difference value between pixel values of pixels of the standard image and a pixel values of a pixels of the motion compensation image; and

a threshold value processing section that determines whether block noise is contained in the motion compensation image of a block unit or not by performing a threshold value processing on the difference value.

(2) The image processing apparatus according to (1),

wherein the difference calculation detection section calculates the difference value between the reference image of the block unit and a pixel value of a pixels of the motion compensation image,

the image processing apparatus further includes

an approximation processing section that approximates the difference value to a predetermined function, and

an integration processing section that integrates the predetermined function, and

wherein the threshold value processing section that determines whether block noise is contained in the motion compensation image of the block unit or not by performing the threshold value processing on an integration value obtained by the integration processing section.

(3) The image processing apparatus according to (2),

wherein the difference calculation section calculates the difference value between the pixel values of the pixels at the boundary region adjacent to the adjacent blocks in a target block at the standard image and the motion compensation image.

(4) The image processing apparatus according to (3),

wherein the difference calculation section calculates the difference value between the pixel value of the pixels obtained by sampling the pixels at the boundary region adjacent to the adjacent blocks in the target block.

(5) The image processing apparatus according to (2) to (4),

wherein the threshold value processing section determines whether block noise is contained in the motion compensation image of a block unit or not by comparing an integration value obtained by the integration processing section with threshold value set based on a noise intensity corresponding to a luminosity value of an image.

(6) The image processing apparatus according to (1),

wherein the difference calculation section calculates a difference value between a first differential value obtained by differentiating the pixel value of the pixel of the standard image and a second differential value obtained by differentiating the pixel value of the pixel of the motion compensation image, and

wherein the threshold value processing section determines whether block noise is contained in the motion compensation image of the block unit by performing a threshold value processing on the difference value between the first differential value and the second differential value.

(7) The image processing apparatus according to (6), wherein the difference calculation section calculates the difference value between the first differential value obtained by differentiating the pixel value of the pixels of a boundary region of a target block and an adjacent block, and the second differential value differentiating the pixel value of the pixels of the boundary region of an image of the target block and the adjacent block in the motion compensation image.

(8) The image processing apparatus according to (7), wherein an average calculation section calculating an average value of the difference value of the boundary region of the block is further provided, and

wherein the threshold value processing section determines whether block noise is contained in the motion compensation image of the block by performing a threshold value processing on the average value calculated by the average calculation section.

(9) The image processing apparatus according to (6) to (8),

wherein the threshold value processing section determines whether block noise is contained in the motion compensation image of the block unit by comparing the difference value between the first differential value and the second differential value with the threshold value set based on the noise intensity corresponding to the luminosity value of the image.

(10) The image processing apparatus according to (1), further including

a differential processing section differentiating the difference value calculated by the difference calculation section,

wherein the threshold value processing section determines whether block noise is contained in the motion compensation image of the block unit by performing the threshold value processing on the integration value calculated by the differential processing section.

(11) The image processing apparatus according to (10),

wherein the differential processing section differentiates the difference value of the boundary region between the target blocks and the adjacent block.

(12) The image processing apparatus according to (11),

wherein further including an average value calculation section calculating the average value of the differential value of the boundary region in the block, and

wherein the threshold value processing section determines whether block noise is contained in the motion compensation image of the block by performing the threshold value processing on the average value calculated by the average value calculation section.

(13) The image processing apparatus according to (10) to (12), wherein the threshold value processing section determines whether block noise is contained in the motion compensation image of the block unit by comparing the differential value calculated by the differential processing section with the threshold value set based on the noise intensity corresponding to the luminosity value of the image.

(14) An image processing method of a image processing apparatus which includes

a motion estimation processing section that detects a motion vector of a block unit having an image from a standard image and a reference image;

a motion compensation processing section that produces the motion compensation image by performing a motion compensation of the reference image using the motion vector;

a difference calculation section that calculates a difference value of pixel values of pixels of the standard image and pixel values of pixels of the motion compensation image; and

a threshold value processing section that determines whether block noise is contained in the motion compensation image of a block unit by performing a threshold value processing on the difference value,

the method including:

detecting the motion vector of the block unit having an image from the standard image and the reference image;

producing the motion compensation image by performing the motion compensation of a reference image using the motion vector;

calculating a difference value between pixel values of pixels of the standard image and pixel values of pixels of a motion compensation image; and

determining whether block noise is contained in the motion compensation image of a block unit by performing the threshold value processing on the difference value.

(15) A program causing a computer to execute a process including:

detecting a motion vector of a block unit having an image from a standard image and a reference image;

producing a motion compensation image by performing a motion compensation of the reference image using the motion vector;

calculating a difference value between pixel values of pixels of the standard image and pixel values of pixels of the motion compensation image; and

determining whether block noise is contained in the motion compensation image of a block unit by performing a threshold value processing on the difference value.

(16) A recording medium storing a program causing a computer to execute process including:

detecting a motion vector of a block unit having an image from a standard image and a reference image;

producing the motion compensation by performing the motion compensation of the reference image using the motion vector;

calculating the difference value between the pixel values of pixels of the standard image and the pixel value of the pixels of the motion compensation image; and

determining whether block noise is contained in the motion compensation image of the block unit by performing the threshold value on the difference value.

The present disclosure contains subject matter related to that disclosed in Japanese Priority Patent Application JP 2011-220070 filed in the Japan Patent Office on Oct. 4, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a motion estimation processing section that detects a motion vector of block units which configure an image from a standard image and a reference image;
a motion compensation processing section that produces a motion compensation image by performing motion compensation of the reference image using the motion vector;
a difference calculation section that calculates a difference value between pixel values of pixel of the standard image and pixel values of pixels of the motion compensation image; and
a threshold value processing section that determines whether block noise is contained in the motion compensation image of a block unit or not by performing a threshold value processing on the difference value.

2. The image processing apparatus according to claim 1,
wherein the difference calculation detection section calculates the difference value between the reference image of the block unit and pixel value of pixel of the motion compensation image,
wherein the image processing apparatus further comprises
an approximation processing section that approximates the difference value to a predetermined function, and
an integration processing section that integrates the predetermined function, and
wherein the threshold value processing section determines whether block noise is contained in the motion compensation image of the block unit or not by performing the threshold value processing on an integration value obtained by the integration processing section.

3. The image processing apparatus according to claim 2,
wherein the difference calculation section calculates the difference value between the pixel values of the pixels at the boundary region adjacent to the adjacent blocks in a target block at the standard image and the motion compensation image.

4. The image processing apparatus according to claim 3,
wherein the difference calculation section calculates the difference value between the pixel values of the pixels obtained by sampling the pixels at the boundary region adjacent to the adjacent blocks in the target block at the standard image and the motion compensation image.

5. The image processing apparatus according to claim 2,
wherein the threshold value processing section determines whether block noise is contained in the motion compensation image of a block unit or not by comparing an integration value obtained by the integration processing section with threshold value set based on a noise intensity corresponding to a luminosity value of an image.

6. The image processing apparatus according to claim 1,
wherein the difference calculation section calculates a difference value between a first differential value obtained by differentiating the pixel values of the pixels of the standard image and a second differential value obtained by differentiating the pixel value of the pixels of the motion compensation image, and
wherein the threshold value processing section determines whether block noise is contained in the motion compensation image of the block unit by performing a threshold value processing on the difference value between the first differential value and the second differential value.

7. The image processing apparatus according to claim 6,
wherein the difference calculation section calculates the difference value between the first differential value obtained by differentiating the pixel values of the pixels at a boundary region in a target block and an adjacent block in the standard image, and the second differential value obtained by differentiating the pixel values of the pixels at the boundary region of an image in the target block and the adjacent block in the motion compensation image.

8. The image processing apparatus according to claim 7, further comprising
an average calculation section that calculates an average value of the difference values at the boundary region in the block,
wherein the threshold value processing section determines whether block noise is contained in the motion compensation image of the block unit by performing a threshold value processing on the average value calculated by the average calculation section.

9. The image processing apparatus according to claim 6,
wherein the threshold value processing section determines whether block noise is contained in the motion compensation image of the block unit by comparing the difference value between the first differential value and the second differential value with the threshold value set based on the noise intensity corresponding to the luminosity value of the image.

10. The image processing apparatus according to claim 1, further comprising
a differential processing section that differentiates the difference value calculated by the difference calculation section,
wherein the threshold value processing section determines whether block noise is contained in the motion compensation image of the block unit by performing the threshold value processing on the integration value calculated by the differential processing section.

11. The image processing apparatus according to claim 10,
wherein the differential processing section differentiates the difference values of the boundary region between the target block and the adjacent block.

12. The image processing apparatus according to claim 11, further comprising
an average value calculation section calculating the average value of the differential values at the boundary region in the block,
wherein the threshold value processing section determines whether block noise is contained in the motion compensation image of the block unit by performing the threshold value processing on the average value calculated by the average value calculation section.

13. The image processing apparatus according to claim 10,
wherein the threshold value processing section determines whether block noise is contained in the motion compensation image of the block unit by comparing the differential value calculated by the differential processing section with the threshold value set based on the noise intensity corresponding to the luminosity value of the image.

14. An image processing method of an image processing apparatus which includes
a motion estimation processing section that detects a motion vector of a block unit having an image from a standard image and a reference image;
a motion compensation processing section that produces a motion compensation image by performing a motion compensation of the reference image using the motion vector;
a difference calculation section that calculates a difference value of pixel values of a pixels of the standard image and pixel values of a pixels of the motion compensation image; and
a threshold value processing section that determines whether block noise is contained in the motion compensation image of a block unit by performing a threshold value processing on the difference value,
the method comprising:
detecting the motion vector of the block unit having an image from the standard image and the reference image;
producing the motion compensation image by performing the motion compensation of the reference image using the motion vector;
calculating a difference value between pixel values of pixels of the standard image and pixel values of pixels of the motion compensation image; and
determining whether block noise is contained in the motion compensation image of the block unit by performing the threshold value processing on the difference value.

15. A program causing a computer to execute a process comprising:
detecting a motion vector of a block unit having an image from a standard image and a reference image;
producing a motion compensation image by performing a motion compensation of the reference image using the motion vector;
calculating a difference value between pixel values of pixels of the standard image and pixel values of pixels of the motion compensation image; and
determining whether block noise is contained in the motion compensation image of a block unit by performing a threshold value processing on the difference value.

16. A recording medium storing a program causing a computer to execute a process comprising:
detecting a motion vector of a block unit having an image from a standard image and a reference image;
producing the motion compensation by performing a motion compensation of the reference image using the motion vector;
calculating the difference value between the pixel values of pixels of the standard image and pixel value of pixels of the motion compensation image; and
determining whether block noise is contained in the motion compensation image of the block unit by performing the threshold value on the difference value.
